(19) United States
(12) Patent Application Publication
(10) Pub. No.: US 2019/0274347 A1
(43) Pub. Date: Sep. 12, 2019

(54) NUTRACEUTICAL FORMULATION FOR MITIGATING KIDNEY STONE FORMATION

(71) Applicant: Whole Nutraceuticals LLC, Findlay, OH (US)

(72) Inventors: Benjamin Patterson, Findlay, OH (US); Thomas Zaciewski, Findlay, OH (US)

(21) Appl. No.: 16/295,079

(22) Filed: Mar. 7, 2019

Related U.S. Application Data
(60) Provisional application No. 62/640,300, filed on Mar. 8, 2018.

(51) Int. Cl. A23L 33/00; A23L 19/00; A23L 25/00; A23L 31/00; A23L 7/10

(52) U.S. Cl. CPC A23L 33/40; A23L 33/30; A23L 19/09; A23V 2002/00; A23L 31/00; A23L 7/198; A23L 25/30

(57) ABSTRACT

A nutraceutical formulation militates against the formation of kidney stones in a human, and includes lemon, banana, kale, flaxseed, and mushroom. The nutraceutical formulation, in certain embodiments, may also contain chickpea. The nutraceutical formulation also omits certain ingredients that would otherwise encourage kidney stone formation or inhibit the inhibitory effects of the other ingredients in mitigating the formulation of kidney stones.

### CROSS REFERENCE TO RELATED APPLICATIONS

This application claims the benefit of U.S. Provisional Application Ser. No. 62/640,300, filed on Mar. 8, 2018. The entire disclosure of the above application is hereby incorporated herein by reference.

### FIELD

The present disclosure relates to nutraceuticals and, more particularly, to a nutraceutical formulation containing natural ingredients for use in mitigating kidney stone formation in humans.

### BACKGROUND

A kidney stone is a hard, crystalline, mineral material formed within the kidney or the urinary tract of an individual. Approximately ten percent to twenty percent of Americans develop kidney stones at some point in their lifetimes. People who have already had more than one kidney stone are prone to developing future kidney stones. Kidney stones form where there is a decrease in urine volume or an increased concentration of stone-forming substances in the urine.

The most common type of kidney stone contains calcium in combination with, either, oxalate or phosphate. However, the vast majority of kidney stones are formed of primarily calcium oxalate. Other chemical compounds that may form stones in the urinary tract include uric acid, ammonium phosphate, and the amino acid cysteine. Metabolic abnormalities, including inherited metabolism disorders, may alter the composition of the urine and increase an individual's risk of stone formation.

In the event of a kidney stone, a doctor may prescribe thiazide diuretic to militate against the formation of calcium-based kidney stones. The doctor may also prescribe allopurinol to mitigate uric acid kidney stone formation. In some cases, allopurinol, and thiazide diuretic may cause patients to have adverse reactions. For example, some known side effects of allopurinol and thiazide diuretics include drowsiness, dizziness, headache, diarrhea, vomiting, stomach discomfort, changes in sense of taste, and muscle pain. However, one may also treat, or militate against, kidney stone formation through natural supplements that do not possess the unwanted side effects associated with pharmaceutical treatment.

Accordingly, there is a continuing need for a nutraceutical formulation that contains natural ingredients that militate against kidney stone formation. Desirably, the nutraceutical formulation may be administered without causing the side effects associated with use of diuretics or allopurinol.

### SUMMARY

In concordance with the instant disclosure, a nutraceutical formulation that contains ingredients that militate against the formation of kidney stones, and which may be administered without causing the side effects associated with use of diuretics or allopurinol, has surprisingly been discovered.

In one embodiment, a nutraceutical formulation is a whole food supplement including lemon, banana, kale, flaxseed and mushroom.

In another embodiment, the nutraceutical formulation has dehydrated or freeze-dried natural ingredients including lemon in a major concentration, banana, kale, flaxseed, and mushroom. Specifically, the citrate in the lemon, potassium, citrate, magnesium and B6 vitamin in the banana, calcium and alkalinity of the kale, the phytate in the flaxseed, and the vitamin D in the mushroom all synergistically function to militate against kidney stone formation. The formulation is orally ingested in a variety of dosage forms, for example, as a drinkable powder or in the form of a capsule or tablet.

In an additional embodiment, natural ingredients within a kidney stone supplement, according to the present disclosure, may include foods rich in citrate (e.g., lemon), phytate (e.g., flaxseed, and chickpea), calcium (e.g., from low oxalate greens such as kale), potassium (e.g., banana, and mushroom), magnesium (e.g., banana, flaxseed, and chickpea), vitamin B6 (e.g., banana, chickpea, and kale), vitamin D (e.g., mushrooms), and non-acidic components that promote alkalinity (e.g., kale and the other major ingredients).

In a further embodiment, a nutraceutical formulation is particularly useful for militating against kidney stone formation. In furtherance of this objective, the nutraceutical formulation is limited to only natural ingredients that militate against kidney stone formation. Certain ingredients that would otherwise encourage the formation of kidney stones or interfere with mitigating kidney stone formation are also intentionally omitted from the formulation. Omitted ingredients may include foods rich in oxalate (e.g., beets, spinach, cranberries, bran, soy products, parsley, rhubarb, celery, most nuts and nut butters, tea, cocoa, etc.), sugars (e.g., high fructose consumption linked to stones), sodium, animal protein, caffeine, foods that promote low pH (i.e., reduce alkalinity), phosphorous (e.g., protein rich, nuts, dairy, and cola), and vitamin C supplements (including synthetic vitamin C).

In an additional embodiment, a nutraceutical formulation may be advantageously manufactured using whole food ingredients. Whole food ingredients contain thousands of nutrients (for example, an apple contains >10,000 known nutrients), so while each whole food ingredient within the nutraceutical formulation is chosen for specific nutrients, the whole food ingredients contain additional nutrients that provide added benefits to the body. The additional nutrients synergistically enhance the efficacious nature and bioavailability of the nutraceutical formulation. Additionally, the whole food nutrients increase the overall alkalinity in the body, which is beneficial for many reasons, including a reduction in cancer, kidney stones, and most chronic diseases. Furthermore, because the nutraceutical formulation is manufactured using whole food ingredients, and not synthetic formulations, the user will be much less likely to overdose on vitamins from the nutraceutical formulation, compared to vitamins in other synthetic formulations.

Further areas of applicability will become apparent from the description provided herein. It should be understood that the description and specific examples are intended for purposes of illustration only and are not intended to limit the scope of the present disclosure.

### DETAILED DESCRIPTION

The following description is merely exemplary in nature and is not intended to limit the present disclosure, application, or uses.

The terminology used in the specification provided herein below is hereby defined to include similar and/or equivalent terms, and/or alternative embodiments that would be considered obvious to one skilled in the art given the teachings of the present patent application. Additionally, the words “a,” “an,” and “one” are defined to include one or more of the referenced item unless specifically stated otherwise. Also, the terms “have,” “include,” “contain,” and similar terms are defined to mean “comprising” unless specifically stated otherwise.

Except where otherwise expressly indicated, all numerical quantities in this description are to be understood as modified by the word “about” in describing the broadest scope of the technology. When describing weight percentages of various ingredients in formulations of the present disclosure, as set forth hereinbelow, the term “about” is hereby defined to mean within plus or minus five weight percent (±5 wt %) by weight relative to a total weight of the formulation.

The present disclosure is directed to a nutraceutical formulation. The nutraceutical formulation may include lemon, banana, kale, flaxseed, and mushroom. In alternative embodiments, the nutraceutical formulation may also include chickpea. Each of these natural ingredients may be dehydrated or freeze-dried and powdered or granulated prior to being incorporated into the nutraceutical formulation. For example, the natural ingredients may be powdered or granulated to a particle size between about 10 microns and about 300 microns, and more particularly between about 100 microns and about 200 microns. However, one of ordinary skill in the art may select other suitable particle sizes, including particle sizes adapted to facilitate water solubility of the nutraceutical formulation as described further herein below, as desired.

In a most specific embodiment, the nutraceutical formulation may be manufactured using whole food non-GMO ingredients. In particular, each of the lemon, the banana, the kale, the flaxseed, the mushroom, and optionally the chickpea, may be processed from whole food ingredients. However, other suitable forms of the ingredients may be chosen as desired. Additionally, each of these natural ingredients may be substantially evenly mixed together according to conventional techniques to provide the nutraceutical formulation for convenient end use, as described further herein. It should be understood that the powdered or granulated form of the natural ingredients facilitates flowability and mixability, and results in a substantially homogenous mixture of the natural ingredients for end use.

In particular examples, the natural ingredients are provided in a dosage form suitable for oral administration, including one or more tablets or artificial capsules, a manufactured or compounded liquid or slurry form, or as a manufactured powder or granulate. As a nonlimiting example, the powder or granulate form of the nutraceutical formulation may be water soluble. In particular, the nutraceutical formulation may be ground to, or otherwise provided in, a particle size that is adapted to naturally dissipate and dissolve within an aqueous medium. It should be appreciated that where the powdered or granulated ingredients of the nutraceutical formulation are dehydrated, the ingredients will furthermore more readily absorb water and dissolve in the aqueous medium, especially in comparison to synthetic vitamin alternatives. One of ordinary skill in the art may also select other suitable dosage forms within the scope of the present disclosure.

It should be appreciated that the capsule dosage form for the nutraceutical formulation may be preferred. Where provided in a capsule dosage form, the artificial capsules may be single-piece or two-piece manufactured bodies for encapsulation of the formulation. As further non-limiting examples, suitable ingredients for the manufactured capsules may include wax, cellulose (including, for example, Hypromellose or HPMC, and sometimes referred to as “veggie capsule”), starches, gelatin, pullulan/tapioca, and combinations thereof. Other suitable ingredients for capsules of the present disclosure may also be employed, as desired.

Other ingredients may be provided in the nutraceutical formulation such as various excipients, including one or more antiadherents, binders, coatings, disintegrants, flavors, colors, lubricants, glidants, sorbents, preservatives, and sweeteners. Excipient examples include one or more of hypromellose, rice flour, brown rice flour, magnesium stearate, cellulose, inulin, and silicon dioxide.

In a most particular embodiment, the excipient may be brown rice flour, and the brown rice flour may be present in the nutraceutical formulation in a minor concentration relative to the other ingredients. For example, the brown rice flour excipient may be present in a concentration ranging from less than about one weight percent wt %) to about four weight percent (4 wt %), more particularly from about one weight percent (1 wt %) to about three weight percent (3 wt %), and most particularly to about two percent (2 wt %), each by weight relative to the total weight of the nutraceutical formulation. The brown rice flour excipient has been found to provide anti-caking properties when used with the other ingredients described herein, which is beneficial during the manufacturing and mixing of the nutraceutical formulation of the present disclosure.

Lemon has been found to treat, and militate against, kidney stone formation. While not being bound to any particular theory, it is believed that the lemon militates against kidney stone formation due to the presence of citrate. However, it should be appreciated that lemon has other naturally occurring bioactive compounds that enhance the efficacy and bioactivity of the citrate. The lemon may also be present in the nutraceutical formulation in a major concentration relative to the other ingredients. For example, the lemon may be present in a concentration ranging from about twenty-five weight percent (25 wt %) to about sixty-five weight percent (65 wt %), more particularly from about thirty-five weight percent (35 wt %) to about fifty-five weight percent (55 wt %), and even more particularly about forty-five weight percent (45 wt %), each by weight relative to the total weight of the nutraceutical formulation. A skilled artisan may also select other suitable concentrations for the lemon component, as desired.

Banana has been found to treat, and militate against, kidney stone formation. While not being bound to any particular theory, it is believed that the banana militates against kidney stone formation due to the presence of potassium, magnesium, and vitamin B6. However, it should be appreciated that banana has other naturally occurring bioactive compounds that increase the efficacy and bioactivity of potassium, magnesium, and vitamin B6. In an non-limiting example, banana may be present in the formulation in a concentration ranging from about three weight percent (3 wt %) to about forty-three weight percent (43 wt %), more particularly from about thirteen weight percent (13 wt %) to about thirty-three weight percent (33 wt %), and most particularly about twenty-three weight percent (23 wt %), each by weight relative to the total weight of the nutraceutical formulation. It should be appreciated that other suitable concentrations for the banana component may also be employed within the scope of the present disclosure.

Kale has further been found to treat, and militate against, kidney stone formation. While not being bound to any particular theory, it is believed that the kale militates against kidney stone formation due to the presence of calcium, vitamin B6, and by contributing to a more basic alkalinity. However, it should be appreciated that kale has other naturally occurring bioactive compounds that may enhance the efficacy and bioactivity of calcium, vitamin B6, and the alkaline properties thereof. In an non-limiting example, the kale may be present in the nutraceutical formulation in a concentration ranging from about one weight percent (1 wt %) to about twenty weight percent (20 wt %), more particularly from about five weight percent (5 wt %) to about fifteen weight percent (15 wt %), and most particularly about ten weight percent (10 wt %), each by weight relative to the total weight of the nutraceutical formulation. One of ordinary skill in the art may also select other suitable concentrations for the kale component, as desired.

Flaxseed has also been found to treat, and militate against, kidney stone formation. While not being bound to any particular theory, it is believed that the flaxseed militates against kidney stone formation due to the presence of phytate and magnesium. However, it should be appreciated that flaxseed has other naturally occurring bioactive compounds that may enhance the efficacy and bioactivity of phytate and magnesium. Flaxseed may be present in the formulation in a concentration ranging from about one weight percent (1 wt %) to about twenty weight percent (20 wt %), more particularly from about five weight percent (5 wt %) to about fifteen weight percent (15 wt %), and most particularly about ten weight percent (10 wt %), each by weight relative to the total weight of the nutraceutical formulation. It should be understood that other suitable concentrations for the flaxseed component may also be selected within the scope of the present disclosure.

Mushroom has been found to treat, and militate against, kidney stone formation. As non-limiting examples, suitable types of mushroom may include white (button or jumbo) mushroom, chanterelle mushroom, oyster mushroom, portobello mushroom, shiitake mushroom, lion's mane mushroom, and cremini mushroom. While not being bound to any particular theory, it is believed that the mushroom militates against kidney stone formation due to the presence of potassium and vitamin D (which is not found in any significant concentrations in fruits and vegetables). However, it should be appreciated that mushroom has other naturally occurring bioactive compounds that may enhance the efficacy and bioactivity of potassium, and vitamin D. In a non-limiting example, mushroom may be present in the formulation in a concentration ranging from about one weight percent (1 wt %) to about twenty weight percent (20 wt %), more particularly from about five weight percent (5 wt %) to about fifteen weight percent (15 wt %), and most particularly about ten weight percent (10 wt %), each by weight relative to the total weight of the nutraceutical formulation. It should be understood that other suitable concentrations for the mushroom component may also be selected within the scope of the disclosure.

In alternative embodiments, the nutraceutical formulation may further include chickpea as an optional ingredient. Chickpea has been found to treat, and militate against, kidney stone formation. While not being bound to any particular theory, it is believed that the chickpea militates against kidney stone formation due to the presence of phytate, magnesium, and vitamin B6. However, it should be appreciated that chickpea has other natural bioactive compounds that may enhance the efficacy and bioactivity of phytate, magnesium, and vitamin B6. In a non-limiting example, chickpea may be present in the formulation in a concentration ranging from about one weight percent (1 wt %) to about twenty weight percent (20 wt %), more particularly from about five weight percent (5 wt %) to about fifteen weight percent (15 wt %), and most particularly about ten weight percent (10 wt %), each by weight relative to the total weight of the nutraceutical formulation. It should be understood that other suitable concentrations for the chickpea component may also be selected within the scope of the disclosure.

It is further believed that the aforementioned natural ingredients, where used in combination in the concentrations described herein, may behave synergistically to mitigate the formation of kidney stones, where the nutraceutical formulation is administered on a consistent and regular basis. For example, whole food products, and particularly lemon, banana, kale, flaxseed, mushroom and, optionally, chickpea, contain thousands of nutrients that can provide added benefits to the body and function synergistic to increase alkalinity within the user. It should be appreciated that an increased alkalinity militates against kidney stone formation by reducing the quantity of calcium oxalate and uric acid crystals, which clump together and form kidney stones.

The present disclosure is not only defined by the ingredients present in the nutraceutical formulation, but also by ingredients purposely omitted or avoided. It should be appreciated that these omitted ingredients do not necessarily militate against kidney stone formation but may inhibit the treatment of kidney stones. These ingredients include beets, spinach, cranberries, bran, soy products, parsley, rhubarb, celery, and most nuts due to the presence of oxalate. Ingredients such as tea and cocoa must also be omitted. Other non-desirable ingredients include those which contribute excess sugars, animal proteins, caffeine, excess phosphorous, and synthetic vitamin C such as ascorbic acid, or any foods that reduce alkalinity. The term “excess” is hereby defined to mean an added amount of the ingredient beyond that which is naturally found in all of the ingredients not to be purposefully omitted or avoided. One of ordinary skill in the art may also determine other such ingredients to be omitted, and particularly ingredients that may otherwise contribute to stone formation and growth, within the scope of the present disclosure.

As may be presented herein, the language “consisting essentially of” is meant to limit the scope of the claim to the specified materials that do not materially affect the basic and novel characteristics of the nutraceutical formulation. It should be appreciated that ingredients rich in oxalate, excess sugar, animal protein, excess phosphorous, and synthetic vitamin C such as ascorbic acid, or any foods that reduce alkalinity, have been shown to materially affect the basic and novel characteristics of the nutraceutical formulation by inhibiting the treatment of kidney stones. Thus, the nutraceutical formulation consisting essentially of lemon, banana, kale, flaxseed, and mushroom, excludes ingredients rich in oxalate, excess sugar, animal protein, excess phosphorous, and synthetic vitamin C such as ascorbic acid, or any foods that reduce alkalinity, which may materially affect the basic and novel characteristics of the nutraceutical formulation.

Additionally, as may be presented in the claims below, the language “consisting of” is intended to exclude any ingredient not specified in the claim. Accordingly, the nutraceutical formulation consisting of lemon, banana, kale, flaxseed, mushroom, and brown rice flour includes only those ingredients.

### Example

In one example, the nutraceutical formulation, including lemon fruit powder, banana fruit powder, kale leaf powder, flaxseed powder, lion's mane mushroom, and brown rice flour is administered to patients in a daily oral dose of about 1540 mg (not including any weight contributed by capsule ingredients). In particular, the dosage amounts of lemon, banana, kale, flaxseed, lion's mane mushroom, and brown rice flour are shown below in TABLE 1.

TABLE 1
Dosage of Nutraceutical Formulation

| Ingredients | Weight | |
|---|---|---|
| Lemon Fruit Powder | 700 | mg |
| Banana Fruit Powder | 350 | mg |
| Kale Leaf Powder | 150 | mg |
| Flaxseed Powder | 150 | mg |
| Lion's Mane Mushroom | 150 | mg |
| Brown Rice flour | 40 | mg |
| TOTAL | 1540 | mg |

The nutraceutical formulation, as shown in TABLE 1 above, will be administered daily to a patient. The urine of the patient will be collected and tested through urinalysis after a 24-hour period. The patient or medical professional will collect the urine in a container over the full 24-hour period. During the collection, the container will be kept at approximately 35 degrees Fahrenheit until the urine is brought to a lab for further testing. The 24-hour collection period begins after a first urination of the 24-hour collection period. The urine from the first urination is discarded, but all urine after the first urination is collected during the 24-hour period and saved for urinalysis.

In particular, where performing the urinalysis, the medical professional will perform a microscopic exam, and analyze the citric acid levels, pH of the urine, magnesium levels, calcium levels, and vitamin D levels within the urine. The microscopic exam is performed by the medical professional, who views drops of urine under a microscope to document the amount of calcium crystals and uric acid crystals. The citrate levels are measured using quantitative spectrophotometry, the calcium is measured using a dual stable isotope method, and vitamin D levels are measured using mass spectrometry. The pH is measured using a pH test strip, which indicates the pH of the urine through a change of color on the strip.

After the urinalysis, the medical professional then determines the level of kidney stone stabilization, and mitigation of kidney stone formation, by using an X-ray, MRI, or ultrasound of the kidney.

While administering the daily dose of the nutraceutical formulation shown above in TABLE 1, the urinalysis is expected to show a decrease in urinary excretion of calcium oxalate crystal per 24-hour urine collection. Calcium oxalate is an indicator of kidney stone formation, since calcium oxalate crystals will develop into calcium oxalate kidney stones. Accordingly, the decreased levels of calcium oxalate crystal will illustrate a mitigation of kidney stone formation.

While administering the daily dose of the nutraceutical formulation shown above in TABLE 1, the urinalysis is expected to show an increase in urinary excretion of citrate per 24-hour urine collection. Increased citrate levels will mitigate the formation of kidney stones by inhibiting the binding of calcium to oxalate or phosphate, thereby reducing calcium crystal formation and the formation of kidney stones

While administering the daily dose of the nutraceutical formulation shown above in TABLE 1, the urinalysis is expected to show an increase in urinary pH. The increased alkalinity provided by the nutraceutical formulation will raise the pH above the solubility quotient for uric acid, thereby militating against uric acid crystallization and kidney stone formation.

While administering the daily dose of the nutraceutical formulation shown above in TABLE 1, the urinalysis is expected to show an increase in magnesium per 24-hour urine collection. This will inhibit the formation of calcium oxalate crystals in urine, thereby mitigating kidney stone crystallization.

The nutraceutical formulation provides also natural calcium and vitamin D, which maintains a normo-calcemic environment that militates against the physiologic breakdown of calcium into kidney stone.

Advantageously, the nutraceutical formulation of the present disclosure may militate against the formation of kidney stones through regular or daily administration of the recited whole foods, and the associated nutrients naturally found therein in small amounts, into the body and blood stream over time. Furthermore, the nutraceutical formulation may be administered without causing the side effects associated with conventional treatments, including the use of diuretics or allopurinol. Since the ingredients of the present nutraceutical formulation are only dried natural food ingredients, and not mega-dosed synthetic and/or fragmented vitamins, etc. the patient cannot overdose on the nutraceutical formulation. Additionally, patients that cannot be administered capsules can either purchase the nutraceutical formulation in bulk powdered form or open the capsules and deposit the nutraceutical formulation into their mouths or into water and drink it in a dissolved or slurry form.

While certain representative embodiments and details have been shown for purposes of illustrating the invention, it will be apparent to those skilled in the art that various changes may be made without departing from the scope of the disclosure, which is further described in the following appended claims.

What is claimed is:

1. A nutraceutical formulation, comprising:
lemon;
banana;
kale;
flaxseed; and
mushroom.

2. The nutraceutical formulation of claim 1, wherein the lemon is present in a concentration ranging from about 25 percent to about 65 percent by weight relative to a total weight of the nutraceutical formulation.

3. The nutraceutical formulation of claim 1, wherein the lemon is present in the nutraceutical formulation in a concentration of about 45 percent by weight relative to a total weight of the nutraceutical formulation.

4. The nutraceutical formulation of claim 1, wherein the banana is present in a concentration ranging from about 1 percent to about 43 percent by weight relative to a total weight of the nutraceutical formulation.

5. The nutraceutical formulation of claim 1, wherein the banana is present in a concentration of about 23 percent by weight relative to a total weight of the nutraceutical formulation.

6. The nutraceutical formulation of claim 1, wherein the kale is present in a concentration ranging from about 1 percent to about 20 percent by weight relative to a total weight of the nutraceutical formulation.

7. The nutraceutical formulation of claim 1, wherein the kale is present in a concentration of about 10 percent, by weight relative to a total weight of the nutraceutical formulation.

8. The nutraceutical formulation of claim 1, wherein the flaxseed is present in a concentration ranging from about 1 percent to about 20 percent, by weight relative to a total weight of the nutraceutical formulation.

9. The nutraceutical formulation of claim 1, wherein the flaxseed is present in a concentration of about 10 percent, by weight relative to a total weight of the nutraceutical formulation.

10. The nutraceutical formulation of claim 1, wherein the mushroom is present in a concentration ranging from about 1 percent to about 20 percent, by weight relative to a total weight of the nutraceutical formulation.

11. The nutraceutical formulation of claim 1, wherein the mushroom is present in a concentration of about 10 percent, by relative to a total weight of the nutraceutical formulation.

12. The nutraceutical formulation of claim 1, wherein the lemon is present in a concentration of about 45 percent, the banana is present in a concentration of about 23 percent, the kale is present in a concentration of about 10 percent, the flaxseed is present in a concentration of about 10 percent, the mushroom is present in a concentration of about 10 percent, and the binder is present in a concentration of about 2 percent, each by weight relative to a total weight of the nutraceutical formulation.

13. The nutraceutical formulation of claim 1, wherein the lemon is provided in the form of freeze-dried lemon fruit powder, the banana is provided in the form of freeze-dried banana fruit powder, the kale is provided in the form of freeze-dried kale leaf powder, the flaxseed is provided in the form of freeze-dried flaxseed powder, and the mushroom is provided in the form of mushroom powder, and all of the freeze-dried lemon fruit powder, the freeze-dried banana fruit powder, the freeze-dried kale leaf powder, the freeze-dried flaxseed powder, and the mushroom powder are mixed together substantially evenly to provide a homogenous mixture.

14. The nutraceutical formulation of claim 1, wherein the mushroom is lion's mane mushroom.

15. The nutraceutical formulation of claim 1, further comprising an excipient.

16. The nutraceutical formulation of claim 15, wherein the excipient is brown rice flour.

17. The nutraceutical formulation of claim 15, wherein the excipient is present in a concentration of about 2 percent by weight relative to a total weight of the nutraceutical formulation.

18. The nutraceutical formulation of claim 1, wherein the nutraceutical formulation does not contain beets, spinach, cranberries, bran, soy products, parsley, rhubarb, celery, nuts, tea, cocoa, excess sugars, animal proteins, caffeine, excess phosphorous, and synthetic vitamin C such as ascorbic acid.

19. A nutraceutical formulation, consisting essentially of:
lemon;
banana;
kale;
flaxseed; and
mushroom.

20. A nutraceutical formulation, consisting of:
lemon;
banana;
kale;
flaxseed;
mushroom; and
brown rice flour.
